(19) United States
(12) Patent Application Publication
(10) Pub. No.: US 2025/0021282 A1
(43) Pub. Date: Jan. 16, 2025

(54) PRINT SYSTEM AND NON-TRANSITORY COMPUTER-READABLE STORAGE MEDIUM THEREFOR

(71) Applicant: BROTHER KOGYO KABUSHIKI KAISHA, Nagoya (JP)

(72) Inventor: Yoshito HOSOMIZO, Konan (JP)

(21) Appl. No.: 18/901,303

(22) Filed: Sep. 30, 2024

Related U.S. Application Data
(63) Continuation of application No. PCT/JP2023/011793, filed on Mar. 24, 2023.

(30) Foreign Application Priority Data
Mar. 30, 2022 (JP) 2022-055497

(51) Int. Cl. G06F 3/12; B41J 29/00; G03G 15/00

(52) U.S. Cl. CPC G06F 3/1267; B41J 29/00; G03G 15/5016; G03G 15/5087; G03G 15/5091; G06F 3/1203; G06F 3/1253

(57) ABSTRACT

A print system comprises a support program and a printing device. The support program supports a general-purpose print program incorporated in an operating system of an information processing device. The printing device has an accumulative printing function. In a case where a process is required from the general-purpose print program, the support program determines user identification information that can handled by the printing device. In a case where execution of a process is required from the general-purpose print program in response to a print instruction, the support program transmits the print job that the user identification information is assigned. The printing device is configured to execute printing based on the print job on a condition that user identification information assigned to the print job matches user identification information received by the printing device.

### REFERENCE TO RELATED APPLICATIONS

This application is a continuation of PCT International Application No. PCT/JP2023/011793 filed on Mar. 24, 2023, and claims priority from Japanese Patent Application No. 2022-055497 filed on Mar. 30, 2022, which are incorporated herein by reference in their entirety.

### BACKGROUND ART

The present disclosure relates to a print system, and a non-transitory computer-readable storage medium containing computer-executable instructions therefor.

In recent years, a technology has been put to practical use in which a printing device is controlled by a general-purpose print program that is incorporated as standard into an operating system (hereinafter referred to as the “OS”) of an information processing device, without using a printing device driver. In this technology, the OS associates the printing device with the OS-standard general-purpose print program in response to detecting the printing device, and thereafter, the information processing device is enabled to cause the printing device to perform printing with the OS-standard general-purpose print program without using a printing device driver in response to receiving a print instruction to the printing device.

### SUMMARY

There are also known printing devices having an accumulative printing function that does not immediately start printing based on a received print job, but holds the data based on that print data in a memory and starts printing based on that accumulated (i.e., stored) data when the user operates the printing device via a user interface to start printing.

When generating print jobs, the OS standard general-purpose print program does not necessarily assign user identification information that can be handled by the printing device to the printing device. Therefore, to realize the accumulative printing using the OS standard general-purpose print program, there is room for improvement.

According to aspect of the present disclosures, there is provided a non-transitory computer-readable recording medium containing computer-executable instructions that are executable by a computer of an information processing device and compatible with a printing device connected with the information processing device. The computer-executable instructions realizes a support program supporting a general-purpose print program incorporated in advance in an operating system of the information processing device. The printing device has an accumulative printing function. In a case where the accumulative printing function is enabled. The printing device is configured to store a print job in a memory of the printing device without starting printing when receiving the print job. The printing device is configured to execute printing based on the print job on a condition that user identification information assigned to the print job matches user identification information received by the printing device. The support program is configured to, when executed by the computer, cause the information processing device to perform, in a case where a process is required from the general-purpose print program and the accumulative printing is enabled, determining user identification information that can handled by the printing device, and in a case where execution of a process is required from the general-purpose print program in response to a print instruction which instructs the general-use printing program to cause the printing device to print an image and is output by an application program implemented in the information processing device and the accumulative printing is enabled, transmitting, to the printing device, the print job that the user identification information is assigned when the user identification information is determined in the determining.

According to aspect of the present disclosures, there is provided a print system comprising a support program implemented in an information processing device and a printing device connected with the information processing device. The support program is executable by a computer of the information processing device and compatible with the printing device. The support program supports a general-purpose print program incorporated in advance in an operating system of the information processing device. The printing device has an accumulative printing function. In a case where the accumulative printing function is enabled, the printing device being configured to store a print job in a memory of the printing device without starting printing when receiving the print job. The support program is configured to, when executed by the computer, cause the information processing device to perform, in a case where a process is required from the general-purpose print program and the accumulative printing is enabled, determining user identification information that can handled by the printing device, and in a case where execution of a process is required from the general-purpose print program in response to a print instruction which instructs the general-use printing program to cause the printing device to print an image and is output by an application program implemented in the information processing device and the accumulative printing is enabled, transmitting, to the printing device, the print job that the user identification information is assigned when the user identification information is determined in the determining. The printing device is configured to execute printing based on the print job on a condition that user identification information assigned to the print job matches user identification information received by the printing device.

### BRIEF DESCRIPTION OF DRAWINGS

FIG. 1 schematically shows a configuration of a print system.

FIG. 2 is a sequence chart showing an example of a procedure when “Print” is selected.

FIG. 3 is a sequence chart showing an example of a procedure when a print instruction is received.

FIG. 4 shows an example of a user name input screen.

FIG. 5A is a sequence chart showing an example of a printing procedure.

FIG. 5B shows an example of an acceptance screen.

FIG. 6 is a sequence chart showing an example of a procedure when receiving a display instruction to display a detailed setting screen.

FIG. 7 is a sequence chart showing another example of a procedure when “Print” is selected.

FIG. 8 shows an example of a detailed setting screen.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

A detailed explanation will be provided below of a personal computer (hereinafter referred to as the “PC”) using a support program in an illustrative embodiment according to aspects of the present disclosure, with reference to the accompanying drawings. In the present disclosure, a support program executable by the PC is described.

### Embodiment

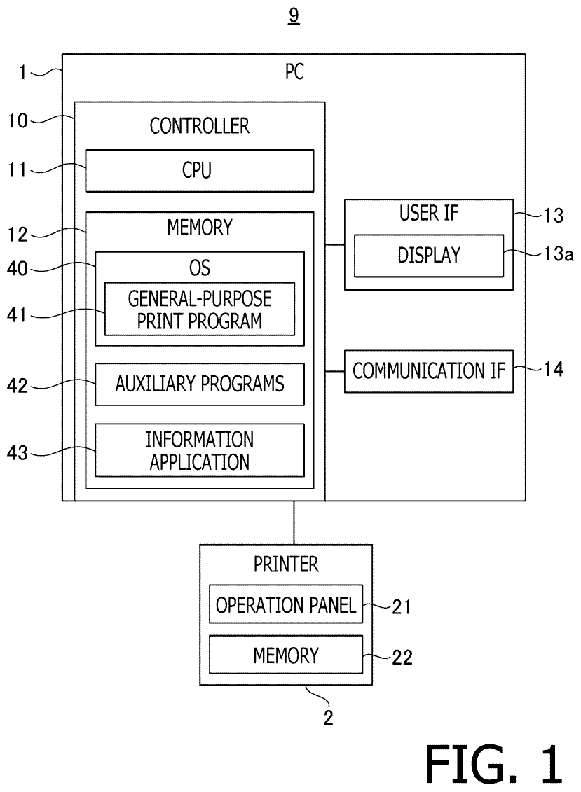

As shown in FIG. 1, a PC 1 of the illustrative embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as the “user I/F”) 13 and a communication interface (hereinafter referred to as the “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes hardware configured to display screens to provide information to the user, and hardware configured to receive user operations. The user I/F 13 may have a combination of a display 13a configured to display information, and a mouse and/or a keyboard that are configured to accept user input operations, i.e., having an input acceptance function. The user I/F 13 may include a touch panel having the display 13a and the input acceptance function.

The communication I/F 14 includes hardware configured to communicate with external devices such as a printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 may be configured to connect with the Internet via the communication I/F 14. The PC 1 may have a plurality of communication I/Fs 14 conforming to a plurality of communication standards. The printer 2 may be an example of a “printing device” according to aspects of the present disclosure.

As shown in FIG. 1, the memory 12 of the PC 1 stores an operating system (hereinafter referred to as the “OS”) 40 including a general-purpose print program 41, and further stores auxiliary programs 42 and various application programs (hereinafter, which may be referred to as the “applications”). Examples of the OS 40 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC).

The OS 40 typically supports multiple languages, such as English, Chinese and Japanese. At the time of setting up of the PC 1, for example, one of the multiple languages supports is selected as a usage language of the OS 40. A login user name to be used when a user logs in to the PC 1 is registered in the OS 40. The login user name is expressed in the language that is selected in the OS 40 when the setup of the PC 1 is performed.

The PC 1 in the illustrative embodiment incorporates various applications such as an information application 43. The information application 43 is, for instance, a map application, a calendar application, or a browser. The information application 43 is configured to, when executed by the CPU 11, cause the PC 1 to display various types of information on the display 13a in response to user requests. The information application 43 may be an example of an “application program” according to aspects of the present disclosure. The information application 43 itself may not necessarily have a function to print the displayed information.

The general-purpose print program 41 is an OS-standard program provided with the OS 40 and has a function to cause the printer 2 to print information that is displayed on the display 13a by the information application 43. The general-purpose print program 41 in the illustrative embodiment is a program having a function for generating intermediate image data based on image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The general-purpose print program 41 is configured to accept print settings for the functions the general-purpose print program 41 supports via a general-purpose print setting screen. Further, the general-purpose print program 41 is configured to set user identification information to be assigned to the print job when the print job is transmitted to the printer that is selected via the general-purpose print setting screen. The general-purpose print program 41 is configured, for example, to set user identification information using the login user name registered in the OS 40. The login user name may consist only of a user name that identifies the user, or may include additional information such as device information added to the user name.

The auxiliary programs 42 include one program or a group of programs configured to, when executed by the CPU 11, cause the PC 1 to perform processing based on instructions from the OS 40, accompanying processing by the general-purpose print program 41. The auxiliary programs 42 include one or more programs that support control of target hardware elements. The auxiliary programs 42 in the illustrative embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HAS” is an abbreviation for “Hardware Support Application”).

For instance, the auxiliary programs 42 may include a combination of a plurality of programs each of which is configured to, when executed by the CPU 11, cause the PC 1 to accept execution instructions. In another instance, the auxiliary programs 42 may include one program configured to, when executed by the CPU 11, cause the PC 1 to accept instructions and perform respective different processes according to the accepted instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

The PC 1 according to the present embodiment is, as shown in FIG. 1, connected to the printer 2. The printer 2 is a device having at least a printing function and a communication function. The printer 2 has an operation panel 21 and a memory 22. The operation panel 21 has an operation function that accepts various input operations and a display function that displays information. The memory 22 stores a control program that controls operations of the printer 2, as well as various data. The memory 22 stores, for example, the set values of print settings according to the functions the printer 2 supports.

Examples of print settings stored in the memory 22 include the paper size, duplex/simplex printing, color/monochrome printing, layout printing (N-in-1), and saving printing to reduce the use of colorant. The printer 2 according to the present embodiment has an accumulative printing function. The accumulative printing function is a function that, after receiving a print job with user identification information from an external device such as the PC 1, stores the print job in memory 22 without starting printing of the print job, and executes printing based on the print job on the condition that the user identification information assigned to the print job matches the user identification information received via the operation panel 21. The print settings stored in the memory 22 also include a setting to enable or disable the accumulative printing.

The auxiliary programs 42 are registered with the general-purpose print program 41 or the OS 40 as programs to be launched based on the selection of the printer 2 at the time of installation. The auxiliary programs 42 in the present embodiment can change the user identification information set by the general-purpose print program 41 to user identification information that can be handled by the printer 2 when the accumulative printing is enabled for the selected printer. Changing of the user identification information will be described later. The auxiliary programs 42 in the present embodiment have a function of displaying a detailed setting screen that receives print settings for functions specific to the corresponding printer 2.

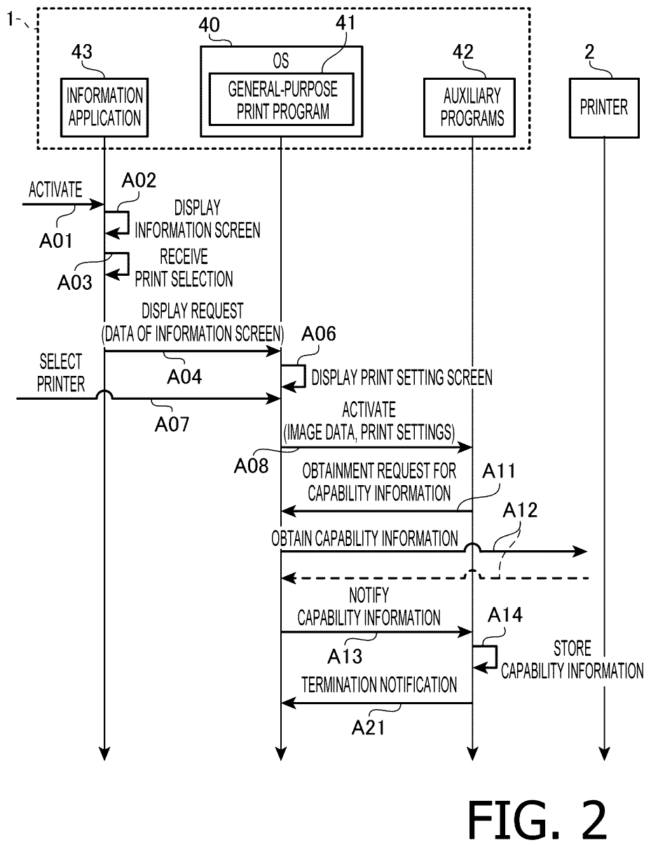

Next, an explanation will be provided of a procedure of printing that includes operations of the auxiliary programs 42 in the illustrative embodiment, i.e., a procedure of operations by the individual programs when printing is selected via the information application 43, with reference to a sequence chart in FIG. 2. In FIG. 2 and after-mentioned other sequence charts, operations when the auxiliary programs 42 compatible with the printer 2 are incorporated in the PC 1 are shown.

Each processing step in the processes, flowcharts and sequence charts in the illustrative embodiment basically indicates processing by the CPU 11 according to the instructions described in the auxiliary programs 42 and other programs. The processing by the CPU 11 includes hardware control using an API (“API” is an abbreviation for “Application Programming Interface”) of the OS 40. In the present disclosure, the operations by the individual programs may be described without a detailed explanation of the OS 40. In addition, “obtaining” and “acquiring” may be used as concepts that do not necessarily require a request.

At the beginning of the procedure, the user starts the information application 43 (A01). The information application 43 displays an information screen containing various types of information on the display 13a in response to user instructions (A02). While displaying the information screen, the information application 43 accepts the selection of “Print” (A03), and when “Print” is selected, the information application 43 transmits a display request and the information screen subject to the general-purpose print program 41 of the OS 40 (A04). While displaying the information screen, the information application 43 is ready to accept the selection of “Print” (A03), and when “Print” is selected, the information application 43 transmits the display request and the information screen subject to the general-purpose print program 41 of the OS 40 (A04).

In response to the display request, the general-purpose print program 41 displays the general-purpose print setting screen on the display 13a (A06). The general-purpose print setting screen is a screen that is used to receive instructions for print settings and/or print execution. The general-purpose print setting screen may display a preview of the data received from the information application 43 at A04. The general-purpose print setting screen can accept the selection of a target printer to perform printing.

The general-purpose print program 41 can accept printer selection during the display of the general-purpose print setting screen (A07). For example, if the selected printer is the printer 2, the general-purpose print program 41 starts the auxiliary programs 42 and requests processing corresponding to the selection of the printer 2 (A08). In A08, the general-purpose print program 41 passes information about the selected printer and the print settings that had been set when the printer was selected to the auxiliary programs 42.

If the printer 2 is set as the printer normally used in the OS 40, the general-purpose print program 41 displays the general-purpose print setting screen with the printer 2 selected (A06) and starts the auxiliary programs 42 (A08). In other words, the printer 2 is automatically selected by the OS 40, and the general-purpose print program 41 executes A08 based on the information of the selected printer 2. In such a case, the user does not need to perform the operation at A07.

Instead of the general-purpose print program 41 displaying the general-purpose print setting screen, the information application 43 may be configured to display the general-purpose print setting screen. In such a case, the information application 43 starts the general-purpose print program 41 in response to the selection of “Print” in A03, obtains the data to be displayed on the general-purpose print setting screen from the general-purpose print program 41, and displays the general-purpose print setting screen on the display 13a. Then, the information application 43 passes the information of the selected printer 2 to the general-purpose print program 41 in response to the printer 2 being selected. In this way, the general-purpose print program 41 starts the auxiliary programs 42 at A08.

The auxiliary programs 42, in response to being activated, request the OS 40 for the capability information of the selected printer (A11). If, for example, the printer 2 is selected at A07, the OS 40 transmits an obtain request for the capability information to the printer 2 upon request from the auxiliary programs 42, and obtains the capability information from the printer 2 (A12). The OS 40 passes the capability information obtained from the printer 2 to the auxiliary programs 42 (A13). The auxiliary programs 42 store the received capability information in the memory 12 (A14) and notify the general-purpose print program 41 of the end of the process requested at A08 (A21). The general-purpose print program 41 may receive the capability information from the auxiliary programs 42 and reflect the same on the general-purpose print setting screen.

The OS 40 communicates with the printer 2, for example, by communication according to the IPP (abbreviation for internet printing protocol). Instead of requesting the information from the OS 40, the capability information may be obtained directly from the printer 2, for example, using an MIB (abbreviation for Management Information Base).

The capability information obtained from the real printer, the printer 2, includes information on the parameters that can be set as print settings. The capability information includes, for example, information indicating whether the accumulative printing is enabled or disabled.

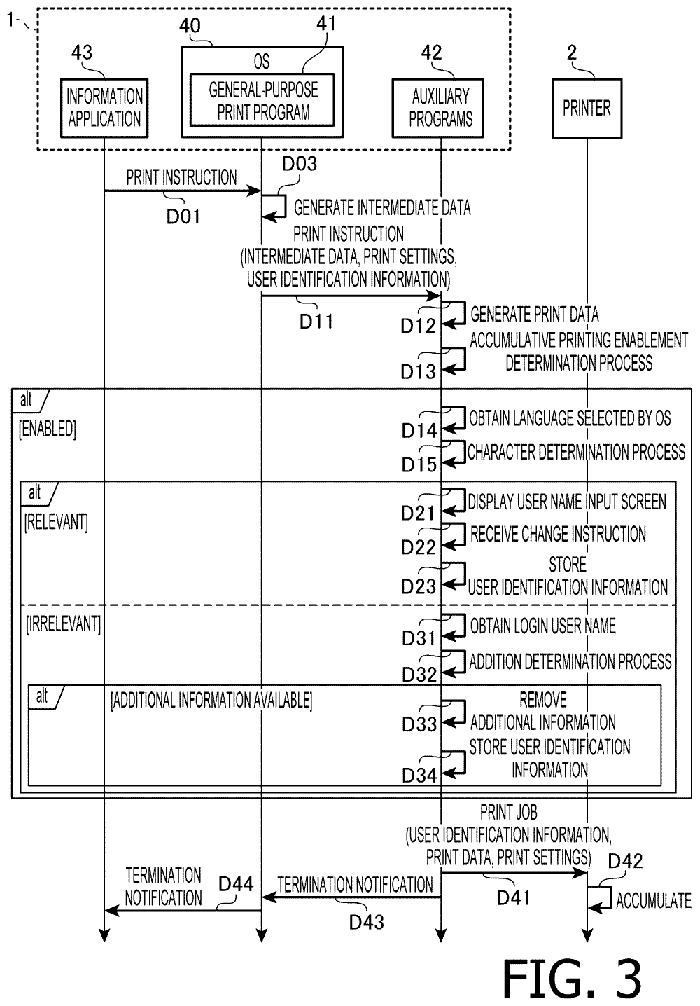

Procedures performed by respective programs when an instruction to execute printing is received via the general-purpose print setting screen are described with reference to FIG. 3. The sequence chart shown in FIG. 3 illustrates an operation when the printer 2 is selected and an instruction to execute printing is received. For example, the general-purpose print setting screen has a print execution button that receives an instruction to execute printing when the button is operated. The general-purpose print setting screen is displayed based on a request by the information application 43, which means that operations to the general-purpose print setting screen are accepted by the information application 43. Therefore, in the present embodiment, the instruction to execute printing is received by the information application 43, and in response to the instruction, the information application 43 outputs printing instructions to the general-purpose print program 41. It should be noted that the information application 43 may directly receive the print execution instruction separately from the general-purpose print setting screen, and in that case, the information application 43 will also output the print instruction to the general-purpose print program 41 in response to such an instruction.

As shown in FIG. 3, when the information application 43 receives a print instruction, which is an instruction to execute printing by the user via the general-purpose print setting screen in which the printer 2 is selected as the printer to be used for printing, the general-purpose print program 41 receives the print instruction with image data indicating the image to be printed from the information application 43 (D01). The general-purpose print program 41 generates intermediate data by converting the format of the received image data into the format of intermediate data (D03). The intermediate data is, for example, the XPS data.

The general-purpose print program 41 starts the auxiliary programs 42 and passes the generated intermediate data and the print settings accepted on the general-purpose print setting screen to the auxiliary programs 42, along with the print instructions (D11). In other words, the general-purpose print program 41 requests the auxiliary programs 42 to perform processing in response to receipt of the print instruction directed to the printer 2, and the auxiliary programs 42 are started. The general-purpose print program 41 sets the user identification information to be assigned to the print job based on the login user name registered in the OS 40 before starting the auxiliary programs 42 at D11. The general-purpose print program 41 passes that user identification information, along with the intermediate data and the like, to the auxiliary programs 42 (D11).

The activated auxiliary programs 42 generate the print data based on the intermediate data (D12). That is, the auxiliary programs 42 apply rasterization to the intermediate data processed by the general-purpose print program 41 to generate print data representing the image to be printed. The print data generated at D12 is, for example, PDL data dedicated to the printer 2. By rasterizing with the auxiliary programs 42 corresponding to the printer 2, the degree of freedom is greater than when rasterizing with the general-purpose print program 41, and print data suitable for printing with the printer 2 is more likely to be generated.

The auxiliary programs 42 that has generated the print data executes an accumulative printing enablement determining process (D13) to determine whether the selected printer is enabled to execute accumulative printing. The capability information of the printer 2 stored in the memory 12 includes information indicating whether the accumulative printing is enabled or disabled. The auxiliary programs 42 read the capability information of the printer 2 from the memory 12, and based on the information contained in the read capability information, determined to whether the printer 2 is enabled to perform the accumulative printing.

If the capability information in the memory 12 contains information indicating that the accumulative printing is enabled, the auxiliary programs 42 determines that the accumulative printing is enabled (alt: enabled). In such a case, the auxiliary programs 42 obtain the language selected by the OS 40 (D14). For example, the auxiliary programs 42 obtain the language selected in the OS 40 by reading the user identification information received from the general-purpose print program 41 at D11. Alternatively, the auxiliary programs 42 may inquire with the OS 40 to obtain the language selected by the OS 40. The auxiliary programs 42 execute a character determining process (D15) to determine whether or not the language obtained at D14 is a language that includes characters that cannot be handled by the selected printer 2.

For example, it is assumed that the selected printer 2 supports English and cannot handle Kanji characters. In such a case, if the language obtained at D14 is Chinese or Japanese, which uses Chinese characters, the auxiliary programs 42 determine that the language obtained at D14 is a language that contains characters that the selected printer 2 cannot handle. On the other hand, if the language obtained at D14 is English, the auxiliary programs 42 determine that the language obtained at D14 is not a language that includes characters that the selected printer 2 cannot handle.

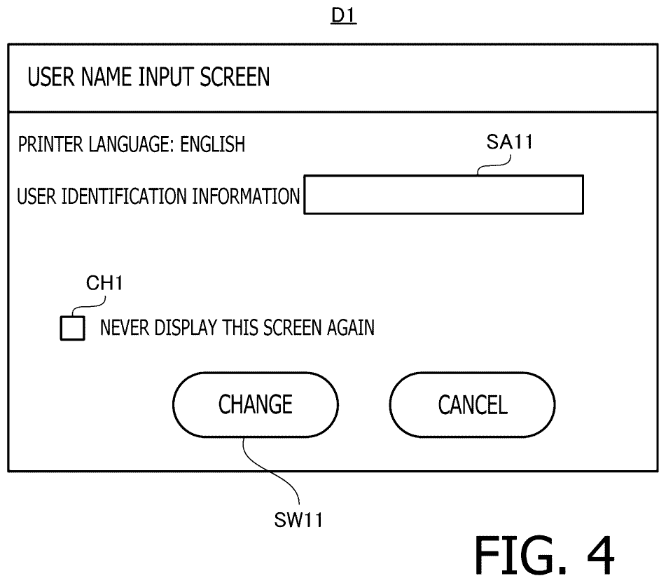

If the auxiliary programs 42 determines in the character determining process that the language obtained in D14 is a language that includes characters that the selected printer 2 cannot handle (alt: relevant), the auxiliary programs 42 displays the user name input screen D1 as shown in FIG. 4 on the display 13a of the PC 1 (D21).

As shown in FIG. 4, the user name input screen D1 has a user identification information input field SA11 for inputting user identification information and a change button SW11 for accepting change instructions to change the user identification information. The user name input screen D1 notifies users of languages that can be handled by the printer 2 (e.g., English), and the user identification information input field SA11 accepts only the input of characters that can be handled by the printer 2. For example, if the language selected in the OS 40 is Chinese or Japanese, including Chinese characters, while the printer 2 supports only American or European languages such as English, French, or the like, the user identification information input field SA1l can accept only the input of characters in the American or European languages, while not accepting the input of Chinese characters. Further, the user name input screen D1 has a check box CHI to accept an instruction to omit the input of the user identification information. If the check box CHI is checked, the auxiliary programs 42 will no longer display the user name input screen D1 next time, even in the case of a language mismatch, that is, a language selected in the OS 40 is not matched with a language supported by the printer 2. On the other hand, if the check box CHI is not checked, the auxiliary programs 42 will redisplay the user name input screen D1 the next time, if it is a language mismatch.

As shown in FIG. 3, when the change instruction is received as the user operates the change button SW11 via the user I/F 13 (D22), the auxiliary programs 42 store the user identification information entered in the user identification information input field SA11 in the memory 12 in association with the user identification information received at D11 (D23). In this way, when the user name input screen D1 is displayed next time, the user identification information stored in D23 is displayed by default in the user identification information input field SA11, thereby saving the user the trouble of entering user identification information. In addition, thereafter, by reading the user identification information from the memory 12, the user identification information assigned by the general-purpose print program 41 will be changed automatically to user identification information that does not contain characters that the printer 2 cannot handle, without having the user input the user identification information on the display 13a by showing the user name input screen D1 on the display 13a. When changing the user identification information to the user identification information stored in the memory 12, the auxiliary programs 42 may ask the user if the user wishes to use the user identification information stored in the memory 12. D22 and D23 may be examples of a decision process according to aspects of the present disclosure.

On the other hand, if the auxiliary programs 42 determines in the character determining process that the language obtained at D14 is not a language that includes characters that the selected printer 2 cannot handle (alt: irrelevant), the auxiliary programs 42 obtain the login user name (D31). The auxiliary programs 42 perform an addition determining process to determine whether the obtained login user name is associated with additional information in addition to the user name (D32).

For example, if the general-purpose print program 41 has the login user name as “[device name]/user name”, the auxiliary programs 42 obtain the user identification information composed by that user name at D11. The auxiliary programs 42 can recognize that the “device name” is additional information added to the “user name” based on the presence of “/”. In this case, the auxiliary programs 42 determine that the login user name contains additional information in addition to the user name (alt: additional information available).

In such a case, the auxiliary programs 42 remove the additional information from the user identification information obtained at D11 (D33). The auxiliary programs 42 change the user identification information obtained at D11 to the user identification information that the additional information is removed and store the changed user identification information in the memory 12 (D34). For example, if the user identification information obtained in D11 is “[device name]/user name”, the auxiliary programs 42 delete the characters before “/” and store the user identification information consisting only of “user name” in the memory 12. In other words, the auxiliary programs 42 can determine user identification information based on the user name. D33 and D34 may be examples of a determining process according to aspects of the present disclosure.

In contrast to the above, if the auxiliary programs 42 determine at D13 that the accumulative printing is not enabled, the auxiliary programs 42 do not change the user identification information received at D11. Further, the auxiliary programs 42 do not change the user identification information received in D11, when it is determined at D13 that the accumulative printing is enabled, but the determination result of the character determining process at D15 is irrelevant and the user identification information obtained at D11 contains no additional information.

Having determined the user identification information, the auxiliary programs 42 assign the user identification information to the print job and transmit the print job to the selected printer 2 (D41). D41 may be an example of a transmitting process according to aspects of the present disclosure. When the accumulative printing is enabled and the user identification information is stored in the memory 12, the auxiliary programs 42 assign the user identification information to the print job. On the other hand, if the accumulative printing is disabled, or the accumulative printing is enabled but the user identification information is not stored in the memory 12, the auxiliary programs 42 assign the user identification information received from the general-purpose print program 41 at D11 to the print job. The print job includes print data, print settings, and print commands as well as user identification information. When the accumulative printing is enabled, the printer 2 stores the print job in the memory 22 in response to receipt of the print job (D42). It should be noted that when the accumulative printing is disabled, the printer 2 performs printing immediately upon receipt of a print job.

After transmitting the print job to the printer 2, the auxiliary programs 42 return a termination notification of the process requested at D11 to the general-purpose print program 41 (D43). The general-purpose print program 41 notifies the information application 43 that printing has been completed (D44).

It is noted that transmission of print data and/or print commands to the printer 2 may be performed by the general-purpose print program 41. That is, the auxiliary programs 42 may pass the determined user identification information and the generated print data to the general-purpose print program 41 in such a manner that the determined user identification information and the generated print data are transmitted from the PC 1 with the printer 2 as the destination. In that case, the general-purpose print program 41 transmits the user identification information, print data, and the like received from the auxiliary programs 42 to the printer 2. In such a configuration, the process in which the auxiliary programs 42 pass the user identification information, print data, and the like to the general-purpose print program 41 may be an example of a transmitting process according to aspects of the present disclosure.

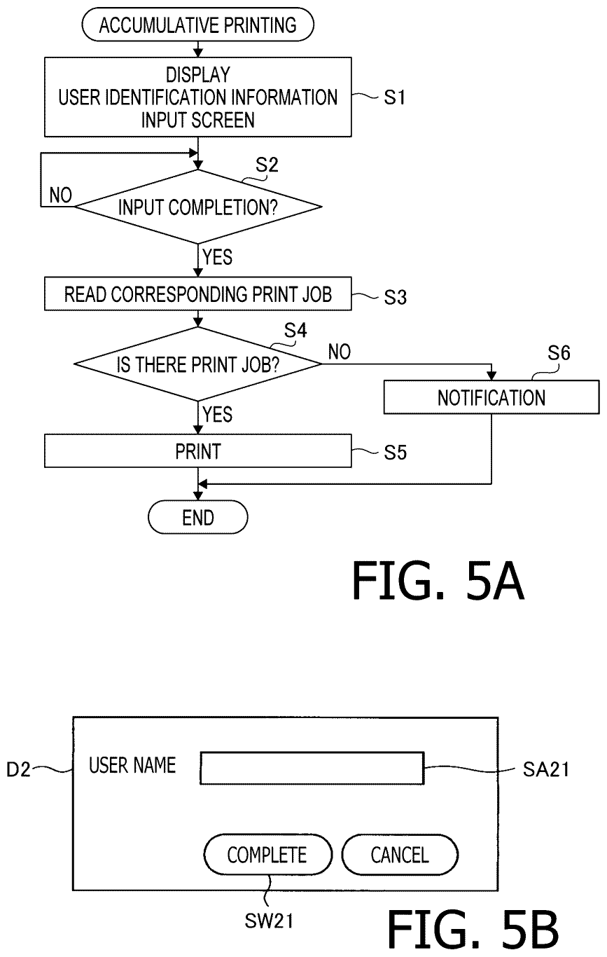

Next, the procedure of the accumulative printing in the printer 2 is explained with reference to a flowchart shown in FIG. 5A. When the accumulative printing function is selected via the operation panel 21, the printer 2 performs the process shown in FIG. 5A.

First, the printer 2 displays the acceptance screen D2 shown in FIG. 5B, for example, on the operation panel 21 (S1). The acceptance screen D2 has an input field SA21 and a completion button SW21. The input field SA21 accepts input of the user identification information. The completion button SW21 receives an instruction of the completion of the input of the user identification information.

As shown in FIG. 5A, the printer 2 that has displayed the acceptance screen D2 determines whether or not the user identification information has been entered (S2). If the completion button SW21 has not been operated, the printer 2 waits with the acceptance screen D2 displayed, since the input of the user identification information has not been completed (S2: NO).

On the other hand, when the completion button SW21 is operated via the operation panel 21, the printer 2 determines that the input of the user identification information has been completed (S2: YES) and reads the print job corresponding to the user identification information entered in the input field SA21 from the memory 22 (S3). The printer 2 determines whether there is a corresponding print job (S4). If the print job corresponding to the user identification information entered in the input field SA21 is in the memory 22 (S4: YES), the printer 2 executes printing of that print job (S5) and terminates the process. On the other hand, if there is no print job corresponding to the user identification information entered in the input field SA21 in the memory 22 (S4: NO), the printer 2 notifies that there is no print job to print (S6) and terminates the process.

It is assumed, for example, that the language selected by the OS 40 is Japanese. Then, the user identification information set by the general-purpose print program 41 may include Chinese characters. In contrast, it is further assumed that the printer 2 supports English but does not support Japanese. When the accumulative printing of the printer 2 is enabled, the auxiliary programs 42 change the user identification information including Japanese to the user identification information composed in English, and transmit the changed user identification information to the printer 2 with the print job being attached thereto. In other words, even when Japanese is selected by the OS 40, the print jobs accumulated in the printer 2 are assigned with the user identification information composed in English, which is supported by the printer 2. Thus, it is possible to avoid a situation in which the printer 2 is unable to read a print job from the memory 22 and unable to execute printing due to a mismatch between the language of the user identification information assigned to the print job and the language of the user identification information entered on the acceptance screen D2.

Further, for example, for the printer 2 with the accumulative printing function, the user identification information consisting only of the user name is entered in the input field SA21 of the acceptance screen D2. If the user identification information assigned to a print job is configured in such a manner that additional information such as a device name is added to the user name, the printer 2 cannot read and execute the print job from the memory 22 because the user name entered on the acceptance screen D2 and the user identification information assigned to the print job do not exactly match. In contrast, when the accumulative printing is enabled, the auxiliary programs 42 assign user identification information consisting only of the user name with additional information such as the device name removed to the print job, and transmit the same to the printer 2. Therefore, it is possible to avoid a situation where the printer 2 cannot read from the memory 22 the print job corresponding to the user identification information entered in the input field SA21 of the acceptance screen D2 due to the additional information and thus cannot execute printing.

It is noted that in the process at S5, the printer 2 may display on the operation panel 21 a list of print jobs corresponding to the user identification information entered on the acceptance screen D2 from among the print jobs stored in the memory 22, and start the printing of the selected print job. Further alternatively, when the user logs into the printer 2 using the user identification information via the acceptance screen D2, the printer 2 may automatically start executing all the print jobs that are stored in the memory 22 and to which the user identification information has been assigned.

As described above, the auxiliary programs 42 in the present embodiment determine the user identification information that can be handled by the printer 2 when processing is requested by the general-purpose print program 41 while the accumulative printing is enabled. When the auxiliary programs 42 receives a print instruction while the accumulative printing is enabled and processing is requested by the general-purpose print program 41, the auxiliary programs 42 transmit the print job with the determined user identification information to the printer 2. In this way, it is possible to reduce the possibility of print jobs with user identification information that cannot be handled by the printer 2 being accumulated in the printer 2, and as a result, the possibility of performing the accumulative printing can be increased.

The auxiliary programs 42 according to the present embodiment accept input to change the user identification information via the user name input screen D1. In this way, it is expected that the user identification information assigned to the print job will be changed from the user identification information including characters that are not supported by the printer 2 to the user identification information consisting of characters that are supported by the printer 2. As a result, the possibility of failure in the accumulative printing due to the language of user identification information is reduced.

There could be a case where the OS 40 has information such as {(device name) ¥ (user name)}, where the device name is appended to the user name, as a login user name. However, many printers often fail to recognize the user name added to the device name as user identification information. According to the auxiliary programs 42 of the present embodiment, with respect to the user identification information consisting of {(device name)/(user name)}, the additional information “device name” is replaced with the user identification information consisting only of the user name. As a result, the user identification information assigned to a print job could be user identification information that is easy to be handled by the printer 2. Therefore, it is possible to avoid a situation where the printer 2 cannot execute printing due to the user identification information including additional information such as device name.

When a print instruction is received and the accumulative printing is enabled, the auxiliary programs 42 of the present embodiment changes the user identification information, assigns the changed user identification information to the print job, and transmits the print job to the printer 2. In this way, for each print job, the auxiliary programs 42 can assign the user identification information that can be handled by the printer 2.

### Modification

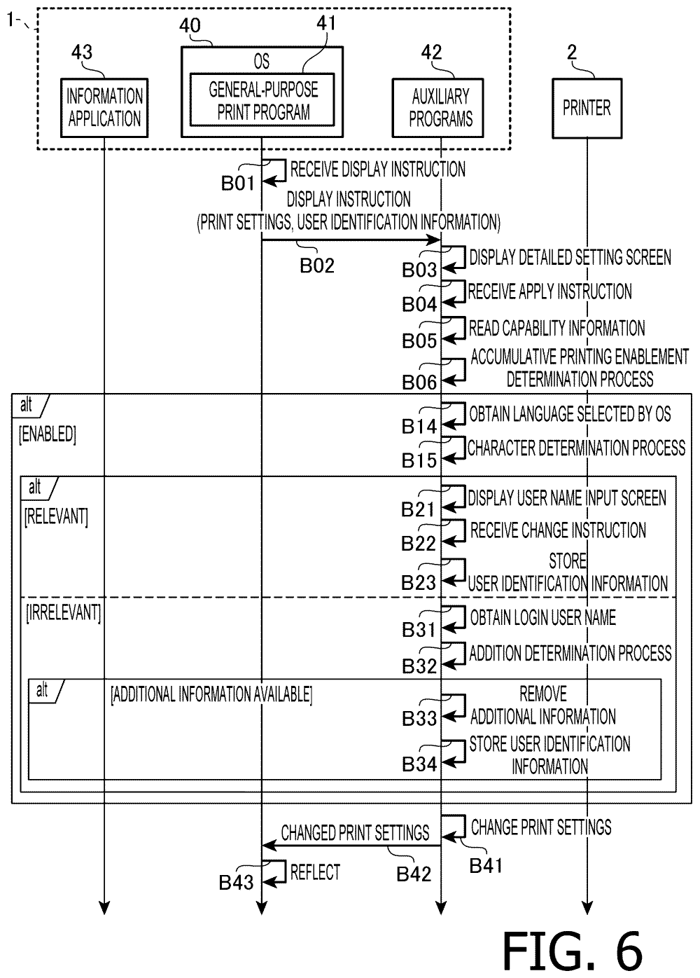

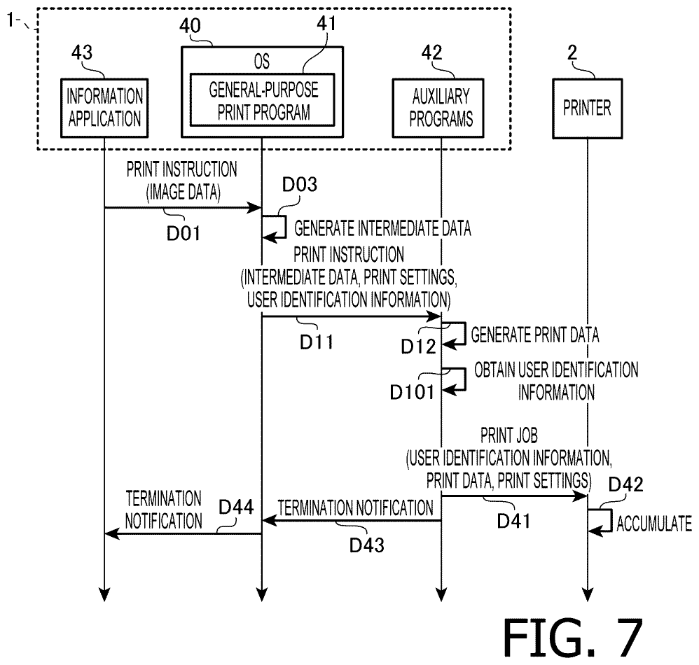

Next, a modification of the embodiment according to aspects of the present disclosure will be described with reference to the drawings. FIG. 6 shows an example of procedures when a display instruction to display a detailed setting screen is received. In the present embodiment, the user identification information to be assigned to a print job is changeable when the detailed setting screen is displayed. This configuration is different from the embodiment explained above in which the user identification information is changed when a print instruction is accepted while the accumulative printing is enabled. The following description focuses on points that differ from the embodiment, and the same symbols as in the embodiment are used for configurations and processes that are common to the embodiment.

According to the present embodiment, the general-purpose print setting screen displayed by the general-purpose print program 41 has a detailed setting button for accepting a display instruction to display a detailed setting screen. As shown in FIG. 6, the general-purpose print program 41 accepts the display instruction in response to a user operation of this detailed setting button (B01). The general-purpose print program 41 invokes the auxiliary programs 42 and instructs to display the detailed setting screen (B02). When invoking the auxiliary programs 42, the general-purpose print program 41 passes the print settings accepted via the general-purpose print setting screen and/or the login user name registered in the OS 40 to the auxiliary programs 42 as the user identification information.

The auxiliary programs 42 display the detailed setting screen on the display 13a (B03). The detailed setting screen has an “Apply” button that instructs to apply a setting value for each item received on the detailed setting screen to the print settings. When receiving the operation of the “Apply” button (B04), the auxiliary programs 42 reads the capability information stored in the memory 12 (B05).

The auxiliary programs 42 performs an accumulative printing enablement determining process (B06) based on the information indicating whether the accumulative printing is enabled or disabled contained in the read-out capability information. The auxiliary programs 42 may obtain the capability information at the time of selecting the printer 2 but not store the same in the memory 12, and obtain the capability information from the printer 2 at the timing of displaying the detailed setting screen and perform the accumulative printing enablement determining process based on the obtained capability information. The capability information may be obtained each time the detailed setting screen is displayed, or may be stored in the memory 12 in association with the printer information once obtained.

If the accumulative printing is enabled (alt: enabled), the auxiliary programs 42 obtain the language selected in the OS 40 (B14) and execute the character determining process (B15). The processes B06, B14, and B15 are similar to the processes D13, D14, and D15 in FIG. 3 above, respectively.

If it is determined that the obtained language is a language that includes characters that cannot be handled by the printer 2 in the character determining process (alt: relevant), the auxiliary programs 42 display the user name input screen, accept the user identification information, and store the same in the memory 12 (B21 to B23). The processes B21 to B23 are similar to the processes D21 to D23 in FIG. 3 above, respectively. B3 may be an example of a storing process according to aspects of the present disclosure.

On the other hand, if the obtained language is not a language that includes characters that cannot be handled by the printer 2 in the character determining process (alt: irrelevant), the auxiliary programs 42 obtain the login user name (B31) and execute the addition determining process (B32). If the auxiliary programs 42 determine in the addition determining process that additional information is added to the login user name (alt: additional information is present), the auxiliary programs 42 remove the additional information (B33) and store the user identification information consisting only of the login user name in the memory 12 (B34). Processes in B31 to B34 are the same as those in D31 to D34 shown in FIG. 3. B34 may be an example of a storing process according to aspects of the present disclosure.

The auxiliary programs 42 change the print settings received at B02 based on the print settings received via the detailed setting screen (B41). The auxiliary programs 42 then pass the changed print settings to the general-purpose print program 41 (B42). The general-purpose print program 41 reflects the print settings received from the auxiliary programs 42 in the setting values on the general-purpose print setting screen (B43).

When there is a print instruction output from the information application 43 that causes the printer 2 to perform printing (D01), the auxiliary programs 42 are activated by the general-purpose print program 41 (D11). When the auxiliary programs 42 generate print data based on intermediate data received from the general-purpose print program 41 (D12), the auxiliary programs 42 read the user identification information from the memory 12 (D101). The auxiliary programs 42 assign the user identification information read from the memory 12 to the print job and transmit the same to the printer 2 (D41). That is, if, as in the present embodiment, processing for changing the user identification information is performed at the timing of displaying the detailed setting screen, the auxiliary programs 42 do not perform processing for changing the user identification information at the timing of receiving the print instruction. The processes after D42 are as described above.

As described above, the auxiliary programs according to the present embodiment determine the user identification information that can be handled by the printer 2 and store the same in the memory 12 by accepting the user identification information via the detailed setting screen when the accumulative printing is enabled. When receiving a print instruction, the auxiliary programs 42 assign the user identification information stored in the memory 12 to the print job and transmits the print job to the printer 2. In this way, the possibility of accumulating print jobs with user identification information that cannot be handled by the printer 2 can be reduced, and as a result, the possibility of performing the accumulative printing with the printer 2 can be increased.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, the device connected with the PC 1 is not limited to printer 2, but may be any device (e.g., multi-function peripheral, copier, and fax machine) having a printing function. The number of printers 2 connected with the PC 1 is not necessarily limited to the example (i.e., one) shown in the relevant drawings.

Furthermore, the processes in FIGS. 3, D23 and D34 it is sufficient to determine the user identification information to be changed and it is not necessary to store the determined user identification information in the memory 12. However, if the changed user identification information is stored in the memory 12, the user will have less trouble entering the user identification information in the user name input screen D1 thereafter.

Even if it is determined that accumulative printing is disabled in D13 of FIG. 3, the user identification information may be changeable. For example, regardless of whether the accumulative printing is enabled or disabled, if a setting to perform printing with user identification information included in a header or a footer is enabled, the user identification information may be changed in the same manner as when the accumulative printing is enabled. In this way, it is possible to avoid printing failures due to inability to print the user identification information including characters that the printer 2 cannot handle in the header or footer.

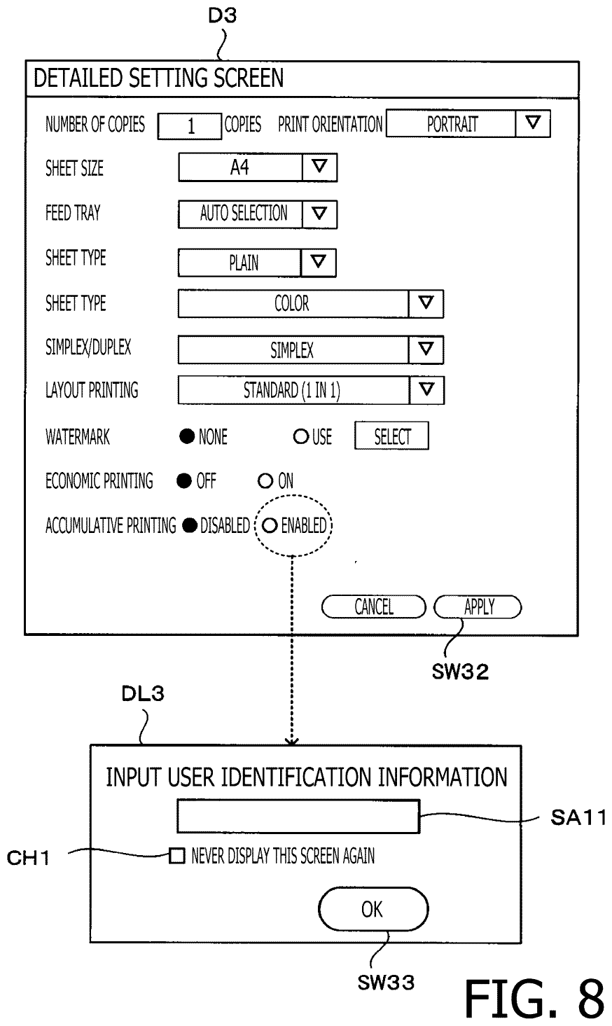

There could be cases where even if the printer has the function of the accumulative printing, the setting for enabling or disabling the accumulative printing is not set on the printer side, but on the PC 1 side. When the setting is made on the PC 1 side, for example, the setting for the accumulative printing is made on the detailed setting screen D3 shown in FIG. 8. In such a case, for example, when the setting of the accumulative printing on the detailed setting screen D3 is switched from “Disabled” to “Enabled”, a user name input screen DL3 will be displayed. The user name input screen DL3, like the user name input screen D1 shown in FIG. 4, has a user identification information input field SA11 and a check box CHI to accept input of user identification information. When an OK button SW33 is operated, the user name input screen DL3 is closed, and the user can set values for other detailed print settings on the detailed setting screen D3. In this case, the auxiliary programs 42 may perform the processes of B06 to B34 in FIG. 6 at the timing when the setting for the accumulative printing is switched from “Disabled” to “Enabled”. As described above, when there is a change in the setting to enable the accumulative printing, the auxiliary programs 42 determine the user identification information and store the same in the memory 12. The auxiliary programs 42 then read that stored user identification information from the memory 12 when transmitting a print job and assign the user identification information to the print job, so that for each print job, the auxiliary programs 42 can assign the user identification information that can be handled by the printer 2. Similarly, if the general-purpose print program 41 can accept the setting for the accumulative printing via the general-purpose print setting screen, the user identification information may be changed at the timing when the setting for the accumulative printing is switched.

In the above-described embodiment, the printer 2 that performs the printing accumulates the print jobs, but a virtual printer that is connected to the PC 1 via the Internet or an external server located on the network connecting the PC 1 and the printer 2 may also be configured to accumulate print jobs. In such a case, the printer 2 may request a virtual printer or an external server on the network to transmit a print job corresponding to the user identification information, receive the print job from the virtual printer or the server, and perform printing based on the thus received print job.

In the aforementioned illustrative embodiment, only the printing operation has been described in detail as the operation by the auxiliary programs 42. However, the auxiliary programs 42 may further have other roles. Examples of the program to perform the processing in the aforementioned illustrative embodiment are not limited to the auxiliary programs 42, but may include any program configured to accept instructions from the OS 40 or the general-purpose print program 41 when printing is performed using the general-purpose print program 41. For instance, a print workflow application (Print workflow) whose specifications have been published by Microsoft Corp. may be included in the examples of the program to perform the processing in the aforementioned illustrative embodiment.

Practicable examples of the execution timing for executing the auxiliary programs 42 are not limited to the example in the aforementioned illustrative embodiment. For instance, the auxiliary programs 42 may be executed in response to a direct execution instruction from the OS 40. In another instance, the auxiliary programs 42 may be resident programs. In this case, the auxiliary programs 42 may perform the aforementioned operations in response to receiving execution commands.

In any flowchart disclosed in the aforementioned illustrative embodiment, a plurality of processes in a plurality of any steps may be arbitrarily changed in the execution order thereof or may be executed in parallel as long as there is no inconsistency in the processing results.

The processing disclosed in the aforementioned illustrative embodiment may be performed by one or more CPUs, one or more hardware elements such as ASICs, or a combination of at least two selected therefrom. The processing disclosed in the aforementioned illustrative embodiment may be implemented in various aspects such as a non-transitory computer-readable storage medium storing computer-readable instructions (e.g., programs) for performing the processing, or a method for performing the processing.

What is claimed is:

1. A non-transitory computer-readable recording medium containing computer-executable instructions that are executable by a computer of an information processing device and compatible with a printing device connected with the information processing device, the computer-executable instructions realizing a support program supporting a general-purpose print program incorporated in advance in an operating system of the information processing device, the printing device having an accumulative printing function, in a case where the accumulative printing function is enabled, the printing device being configured to store a print job in a memory of the printing device without starting printing when receiving the print job, the printing device being configured to execute printing based on the print job on a condition that user identification information assigned to the print job matches user identification information received by the printing device,
wherein, the support program is configured to, when executed by the computer, cause the information processing device to perform:
in a case where a process is required from the general-purpose print program and the accumulative printing is enabled, determining user identification information that can be handled by the printing device; and
in a case where execution of a process is required from the general-purpose print program in response to a print instruction which instructs the general-use printing program to cause the printing device to print an image and is output by an application program implemented in the information processing device and the accumulative printing is enabled, transmitting, to the printing device, the print job that the user identification information is assigned when the user identification information is determined in the determining.

2. The non-transitory computer-readable recording medium according to claim 1,
wherein, the determining comprising: obtaining a login user name of a user logging in the information processing device from the operating system;
determining the user identification information based on the obtained login user name in a case where a language selected on the operating system is not a language containing characters that the printing device cannot handle; and
causing a user interface of the information processing device to display a user name input screen configured to receive input of a user name in a case where a language selected on the operating system is a language containing characters that the printing device cannot handle.

3. The non-transitory computer-readable recording medium according to claim 1,
wherein, the determining comprising:
in a case where the login user name of a user logging in the information processing device is obtained from the operating system and an additional information other than information indicating a user name is added to the obtained login user name, determining the user identification information based on the user name that the additional information is removed.

4. The non-transitory computer-readable recording medium according to claim 3,
wherein, information indicating a device name is added to the obtained login user name as the additional information.

5. The non-transitory computer-readable recording medium according to claim 3,
wherein, in the case where execution of a process is required from the general-purpose print program in response to the print instruction which instructs the general-use printing program to cause the printing device to print an image and is output by the application program implemented in the information processing device and the accumulative printing is enabled, the support program is configured to, when executed by the computer, cause the information processing device to perform:
the determining; and
the transmitting of transmitting, to the printing device, a print job that the user identification determined in the determining is added.

6. The non-transitory computer-readable recording medium according to claim 1,
wherein the support program is configured to cause a display of the information processing device to display a detailed setting screen configured to receive print settings supported by the printing device, the general-purpose printing program being configured to receive a display instruction of the detailed print setting screen,
wherein, in a case where execution of a process is required from the general-purpose print program in response to the display instruction and the accumulative printing is enabled, the support program is configured to, when executed by the computer, cause the information processing device to perform:
the determining; and
storing the user identification information determined in the determining in a memory of the information processing device,
wherein, in the case where execution of a process is required from the general-purpose print program in response to the print instruction which instructs the general-use printing program to cause the printing device to print an image and is output by the application program implemented in the information processing device and the accumulative printing is enabled, the support program is configured to, when executed by the computer, cause the information processing device to perform:
reading the user identification information from the memory when the user identification information is stored in the memory; and
the transmitting of transmitting, to the printing device, the print job that the read user identification determined is added.

7. The non-transitory computer-readable recording medium according to claim 1,
wherein, in a case where execution of a process is required from the general-purpose print program and a setting is changed to enable the accumulative printing, the support program is configured to, when executed by the computer, cause the information processing device to perform:
the determining; and
storing the user identification information determined in the determining in a memory of the information processing device
wherein, in the case where execution of a process is required from the general-purpose print program in response to the print instruction which instructs the general-use printing program to cause the printing device to print an image and is output by the application program implemented in the information processing device and the accumulative printing is enabled, the support program is configured to, when executed by the computer, cause the information processing device to perform:
reading the user identification information from the memory when the user identification information is stored in the memory; and
the transmitting of transmitting, to the printing device, the print job that the read user identification determined is added.

8. A print system comprising a support program implemented in an information processing device and a printing device connected with the information processing device,
wherein the support program is executable by a computer of the information processing device and compatible with the printing device, the support program supporting a general-purpose print program incorporated in advance in an operating system of the information processing device,
wherein the printing device having an accumulative printing function, in a case where the accumulative printing function is enabled, the printing device being configured to store a print job in a memory of the printing device without starting printing when receiving the print job,
wherein, the support program is configured to, when executed by the computer, cause the information processing device to perform:
in a case where a process is required from the general-purpose print program and the accumulative printing is enabled, determining user identification information that can be handled by the printing device; and
in a case where execution of a process is required from the general-purpose print program in response to a print instruction which instructs the general-use printing program to cause the printing device to print an image and is output by an application program implemented in the information processing device and the accumulative printing is enabled, transmitting, to the printing device, the print job that the user identification information is assigned when the user identification information is determined in the determining,
wherein the printing device is configured to execute printing based on the print job on a condition that user identification information assigned to the print job matches user identification information received by the printing device.
